(19) United States
(12) Patent Application Publication
(10) Pub. No.: US 2011/0036694 A1
(43) Pub. Date: Feb. 17, 2011

(54) Option switch application and operation for automatic turn off or on

(76) Inventor: Charles Ernest Daffin, III, Tauahassee, FL (US)

Correspondence Address: CHARLES ERNEST DAFFIN III, 5018 BRADFORDVILLE ROAD, TAUAHASSEE, FL, 32309, US

(21) Appl. No.: 12/658,370

(22) Filed: Feb. 12, 2010

Related U.S. Application Data
(63) Continuation-in-part of application No. 12/583,076, filed on Aug. 14, 2009.

(51) Int. Cl. H01H 43/02

(52) U.S. Cl. 200/33 R

(57) ABSTRACT

A switch having an automatic shut-off or “on” feature which turns off/on the switch after a defined period of time has elapsed. The invention has the option of leaving the toggle or rocker in the original on/off position instead of a physical movement to the other position. The switch would have a timer/sensor for auto turn-off or on, and could have a motion sensor, PIR or Black Body Radiation Detector, clock or any future “human detector” to be developed. One purpose is to make sure the lights, fan or energy using device are guaranteed turned “off” and give the ability to control on/off with other methods. This invention gives the option for the physical toggle or rocked to remain in the original position after switch is turned “off”. It still has the ability to be turned off by manually switching the toggle or rocker to the other position and can continue to use the override buttons. The controls for turning “off” or “on” can be remote, built into the switch itself, with the switch inside the rough-in box or built into the switch cover or remote. The overrides and controls can also be LED illuminated. The invention, if installed into the cover plate, can control another existing switch.

### RELATED APPLICATIONS

The present application is related to U.S. Pat. No. 7,525,058 B1, issued Apr. 28, 2009, for LIGHT SWITCH WITH AUTOMATIC TURN OFF, by Charles Ernest Daffin, included by reference herein.

The present application is a continuation-in-part application of United States patent application, Ser. No. 12/583,076, filed Aug. 14, 2009, for SWITCH WITH AUTOMATIC SHUT_OFF FEATURE AND OVERRIDE FEATURE, by Charles Ernest Daffin, included by reference herein and for which benefit of the priority date is hereby claimed.

### FIELD OF THE INVENTION

The present invention relates to switches and, more particularly, to light, fan & appliance switches that turn OFF or ON after a pre determined period of time

### BACKGROUND OF THE INVENTION

This invention relates generally to the field of electrical control devices. More particularly, the present invention comprises a switch for light, fan or any switched controlled device, having a automatic shut “off” or “ON” feature. This invention is a complement and clarification to invention U.S. Pat. No. 7,525,058 and invention application Ser. No. 12/583,076

### DESCRIPTION OF RELATED ART

The concept of a switch having an automatic shut-off feature is described and claimed by the present inventor in U.S. Pat. No. 7,525,058 (2009) to Daffin, which is hereby incorporated by reference. Such a switch preferably fits within the prior art switch boxes so that they may be installed new or retrofitted into existing installations and easily installed using existing equipment.

The switch disclosed in the Daffin '058 patent is effective for its intended purpose. However, there might be instances clairafied by this present patent application. If desired, the the toggle or rocker switch can stay in existing position when

power goes “off” or “on”, instead of toggling to the other position.

Also switch controls can be in the switch, or cover plate, or remote location, or inside the rough-in box with the switch.

The present invention, installed into the cover plate or inside the rough-in box or remote, can also control another existing switch.

By the switch staying in the previous “on” or “off” position after auto turn-off/on, it might be easier to develop and manufacture. Also could make easier to use in 3-way and 4-way applications.

It would be advantageous to provide a toggle or rocker switch that turns “off” or “on” without the toggle or rocker moving to the other position.

It would also be advantageous to provide the mechanism for turning “off” or “on” located in the switch cover or inside the rough-in box or remote.

It would also be advantageous to have the same “toggle” or “rocker” switch in a cover that can be applied over existing “non toggle” switches, controlling their operation.

It would also be advantageous to have LED indicator lights on the switch or cover for identification.

### SUMMARY OF THE INVENTION

In accordance with prior art invention U.S. Pat. No. 7,525,058 and application Ser. No. 12/583,076, there is provided a switch having an automatic shut-off or “on” feature which turns off/on the switch after a defined period of time has elapsed. This invention has the option of leaving the toggle or rocker in the original on/off position instead of a physical movement to the other position.

The switch would have a timer/sensor for auto turn-off or on, which can incorporate occupancy sensor, motion sensor, PIR or Black Body Radiation Detector, clock or any future “human detector” to be developed. This invention gives the option for the physical toggle or rocker to remain in the original position after switch is turned “off” or “on”. It still has the ability to be turned “off” or “on” by manually switching the toggle or rocker to the other position and can continue to use the override buttons.

The controls for turning “off” or “on” can be remote, built into the switch itself, with the switch inside the rough-in box or built into the switch cover.

The overrides can also be LED illuminated.

The invention, if installed into the cover plate, can control another existing switch.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a rocker and toggle switch with timer, sensors and overrides. U.S. Pat. No. 7,525,058 and patent application Ser. No. 12/583,076;

FIG. 2 is a perspective view of a timer, sensors and overrides placed into the switch or along with the switch inside the rough-in box;

FIG. 3 is a perspective view of an option-timer, sensor and overrides placed into the switch cover instead of the switch;

FIG. 4 is a perspective view of a different functions and controls of the toggle or rocker switch; and

FIG. 5 is a perspective view of a toggle or rocker switch in a cover plate and installed over an existing switch or existing timer/sensor switch making the existing switch operational with a toggle or rocker and/or controled by timer/sensor inside the cover plate option to override existing switch controls.

For purposes of clarity and brevity, like elements and components will bear the same designations and numbering throughout the Figures.

### DESCRIPTION OF THE PREFERRED EMBODIMENT

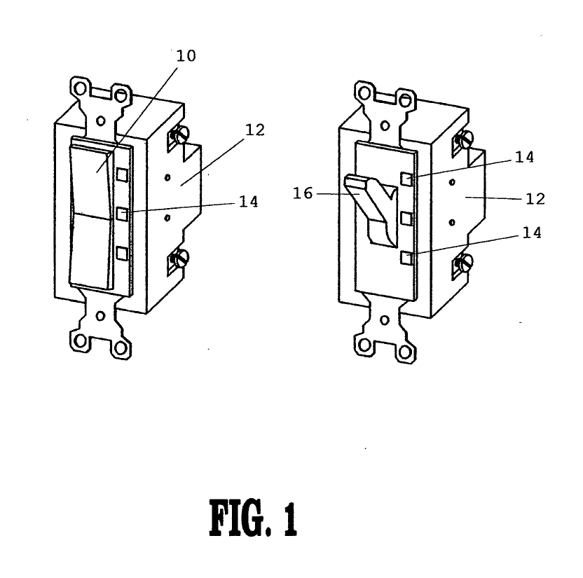

FIG. 1 shows a prior art switch U.S. Pat. No. 7,525,058 with timer/sensor 12 incorporating popular rocker 10 and toggle 16 with override 14, patent application Ser. No. 12/583,076. Override 14, when activated would change preset time to longer or shorter times. Timer/sensor 12 controls can be separate from cover plate 18 or switch itself, and be installed in rough-in box 24 or outside, remote.

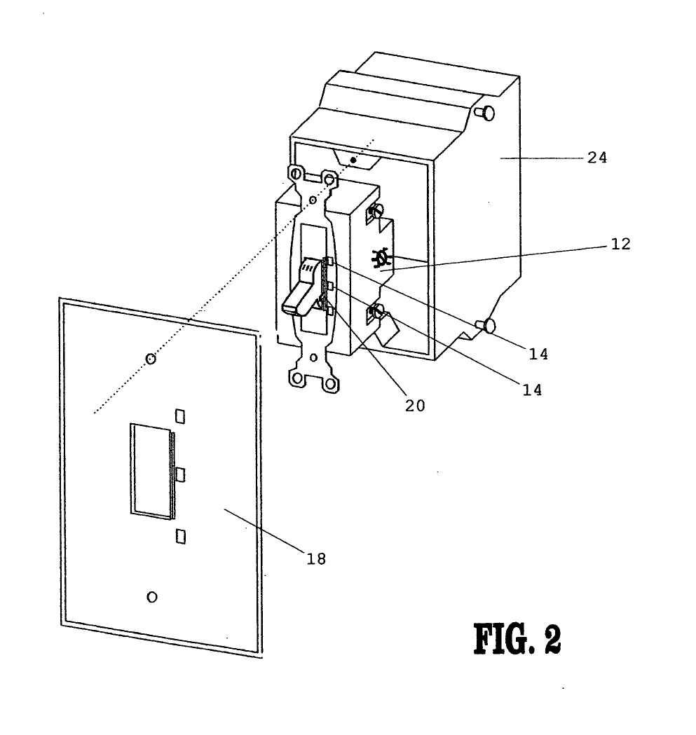

FIG. 2 shows prior art U.S. Pat. No. 7,525,058 with override 14 and dimmer 20 control installed into rough-in box 24 with cover plate 18. dimmer 20, timer/sensor 12

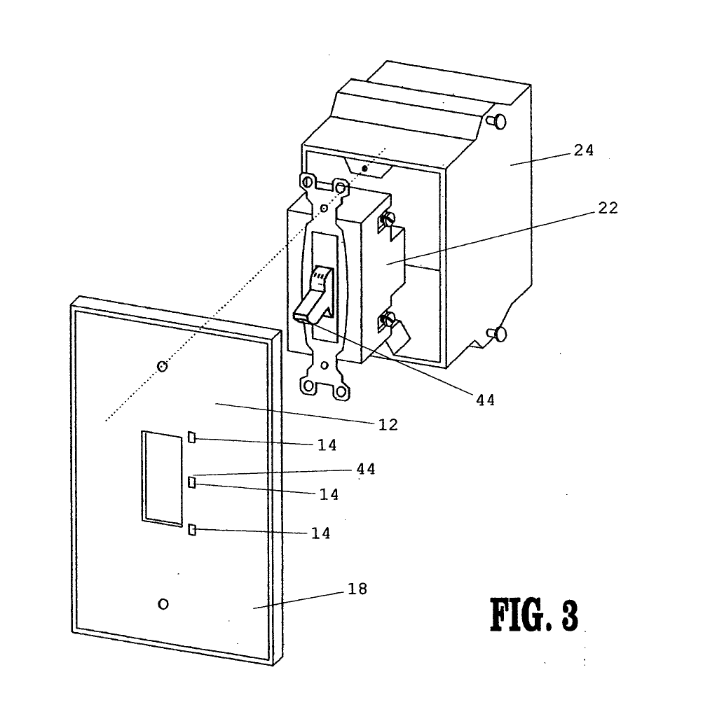

FIG. 3 shows standard switch with cover plate 18 that has controls built into cover instead of switch. Timer/sensor 12, override 14, optional LED 44. timer/sensor 12 controls “on”-“off” and monitors switch. Such as power consumption, dimmer 20, time settings, overrides and other functions. Timer/sensor 12, as defined, can also have motion sensor, infrared, clock, heat sensor, PIR or Black Body Radiation Detector, any future “human detector”.

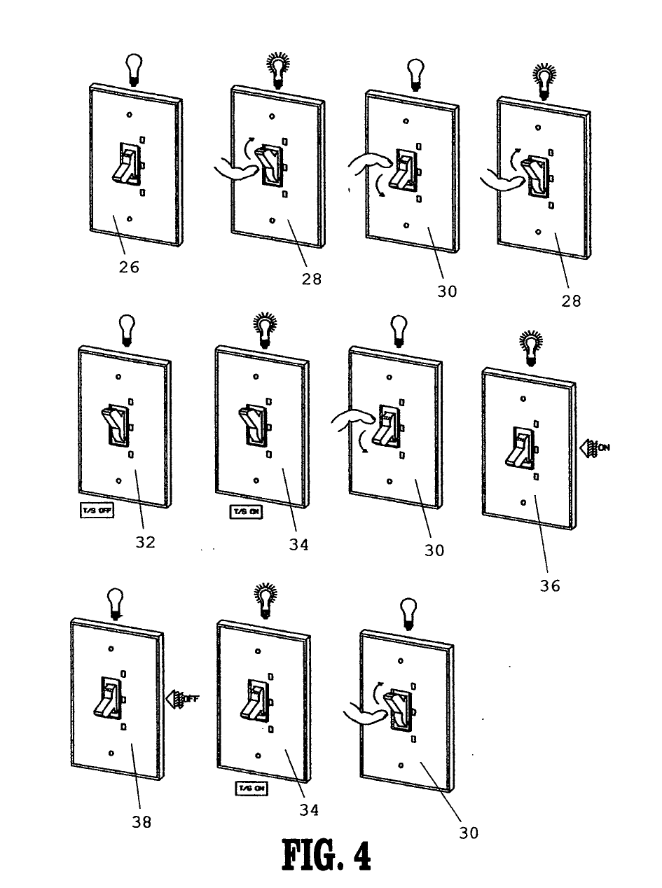

FIG. 4 shows situations and switch positions, switch off 26, switch manually turned ON 28, switch manually turned OFF 30, timer/sensor turns OFF 32, timer/sensor turns ON 34, remote control ON 36, remote control OFF 38. Left to right, top to bottom. First, top left, shows switch “off”. Next, shows switch turned on by hand. The toggle 16 or rocker 10 flipped to “up” position. Next, hand motion, manually, flip toggle 16 down, turning power “off”. Next, manually flip toggle 16 “up” turning power back “on”. Next, middle row left side, Timer/sensor 12 turns power “off” without toggle 16 moving to an up or down position. Next, timer/sensor 12 turns power “on” without toggle 16 moving to another position. Next, manually flit toggle 16 to down position, turning power “off”. Next, outside remote controller turning power “on” without moving toggle 16 to another position. Next, bottom row left, remote turns power “off” while toggle 16 remains in original position. Next, timer/sensor 12 turns power “on”, toggle 16 remains in position. Next, manually move toggle 16 to “up” position, turning power “off”. The timer/sensor 12 or remote can also turn power “on” and “off” and physically move toggle 16 or rocker 10 to another position if so desired. Also LED 44 can illuminate showing an action has been set or illuminating the toggle 16 or rocker 10.

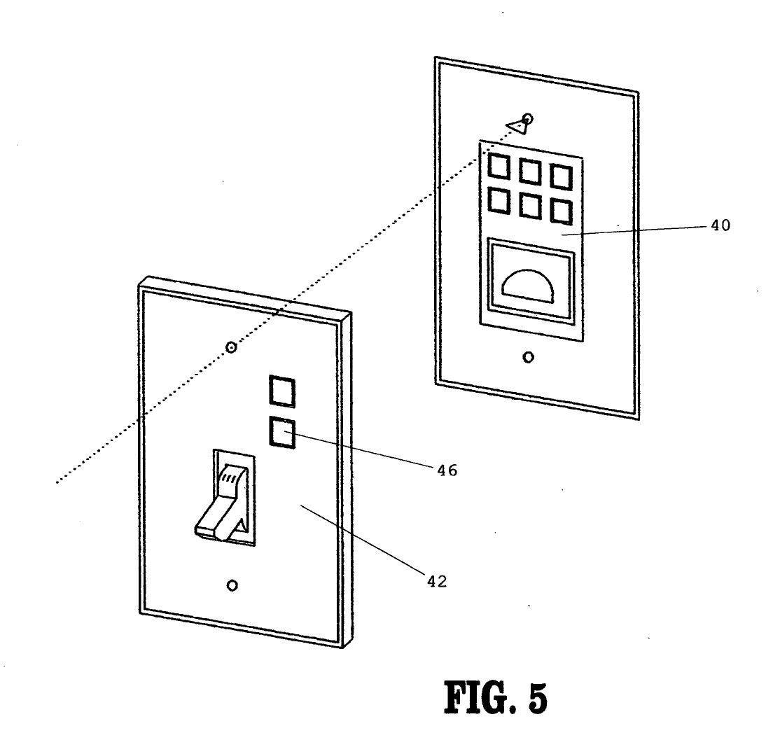

FIG. 5 shows the toggle or rocker cover plate 42 used to turn an existing timer switch 40 into common, popular, toggle 16/rocker 10 instead of push button. the toggle or rocker cover plate 42 also cleans up the cluttered look of present market timer switches and simplifies their operation operation. After installing the cover plate 18 over the existing switch, the toggle 16 or rocker's movement would depress or activate the existing timer switch 40 “on”/“off” button or power controller. The switch plate control access 46 allow access to the existing timer switch 40 different time settings. Switch plate can also hold its own timer/sensor 12, override 14 and remote controls. Having it control an existing device.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An option switch application and operation for automatic turn off or on, comprising:
means for tiem, clock, human/motion sensor;
means for override fixed time;
means for <purpose>;
means for turn power off;
means for timer/sensor turns on;
means for outside remote control turns on;
means for outside remote turns off;
means for to activate the existing timer or sensor switch with the common toggle or rocker switch and allow windows (holes) for access to switch settings; and
means for access other switch controls.

2. The option switch application and operation for automatic turn off or on in accordance with claim 1, wherein said means for tiem, clock, human/motion sensor comprises a timer/sensor.

3. The option switch application and operation for automatic turn off or on in accordance with claim 1, wherein said means for override fixed time comprises an override.

4. The option switch application and operation for automatic turn off or on in accordance with claim 1, wherein said means for <purpose> comprises a switch manually turned on.

5. The option switch application and operation for automatic turn off or on in accordance with claim 1, wherein said means for turn power off comprises a timer/sensor turns off.

6. The option switch application and operation for automatic turn off or on in accordance with claim 1, wherein said means for timer/sensor turns on comprises a timer/sensor turns on.

7. The option switch application and operation for automatic turn off or on in accordance with claim 1, wherein said means for outside remote control turns on comprises a remote control on.

8. The option switch application and operation for automatic turn off or on in accordance with claim 1, wherein said means for outside remote turns off comprises a remote control off.

9. The option switch application and operation for automatic turn off or on in accordance with claim 1, wherein said means for to activate the existing timer or sensor switch with the common toggle or rocker switch and allow windows (holes) for access to switch settings comprises a toggle or rocker cover plate.

10. The option switch application and operation for automatic turn off or on in accordance with claim 1, wherein said means for access other switch controls comprises a control access.

11. An option switch application and operation for automatic turn off or on, comprising:
a timer/sensor, for tiem, clock, human/motion sensor;
an override, for override fixed time;
a switch manually turned on, for <purpose>;
a timer/sensor turns off, for turn power off;
a timer/sensor turns on, for timer/sensor turns on;
a remote control on, for outside remote control turns on;
a remote control off, for outside remote turns off;
a toggle or rocker cover plate, for to activate the existing timer or sensor switch with the common toggle or rocker switch and allow windows (holes) for access to switch settings; and
a control access, for access other switch controls.

12. An option switch application and operation for automatic turn off or on, comprising:
a timer/sensor, for tiem, clock, human/motion sensor;
an override, for override fixed time;
a switch manually turned on, for <purpose>;
a timer/sensor turns off, for turn power off;
a timer/sensor turns on, for timer/sensor turns on;
a remote control on, for outside remote control turns on;
a remote control off, for outside remote turns off;
a toggle or rocker cover plate, for to activate the existing timer or sensor switch with the common toggle or rocker switch and allow windows (holes) for access to switch settings; and
a control access, for access other switch controls.

13. A switch application and operation, wherein said means for item, the toggle or rocker switch can stay in existing position when power goes “off” or “on”, instead of toggling to the other position. A toggle or rocker switch that turns “off” or “on” without necessarily physically moving to another position.

14. A switch application and operation, wherein said means for timer/sensor, as explained previous, may be located in the switch, cover plate, inside or outside the rough-in box, or in remote location

15. A switch application and operation, comprising the timer/sensor controls, defined previously, located in the switch cover plate enabling such cover plate to control another existing switch or control device.

16. A switch application and operation, comprising LED indicator lights.
